(19) United States
(12) Patent Application Publication
(10) Pub. No.: US 2010/0321493 A1
(43) Pub. Date: Dec. 23, 2010

(54) APPARATUS AND METHOD FOR REMOTE MONITORING

(75) Inventors: Mark J. Huber, Burbank, CA (US); William Gibbens Redmann, Glendale, CA (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/735,986

(22) PCT Filed: Dec. 19, 2008
(86) PCT No.: PCT/US2008/013876

§ 371 Date: Aug. 30, 2010

Related U.S. Application Data
(60) Provisional application No. 61/068,524, filed on Mar. 7, 2008.

(51) Int. Cl. H04N 7/18

(52) U.S. Cl. 348/143; 348/E07.085

(57) ABSTRACT

A method and system are provided for remote monitoring of displayed content. The system includes a monitoring device for receiving visual information containing the displayed content and at least one component for generating a defect for combining with the received visual information.

### CROSS REFERENCES

This application claims priority to a U.S. Provisional Application Ser. No. 61/068,524, “Scarred Camera for Remote Monitoring of a Motion Picture” filed on Mar. 7, 2008, which is herein incorporated by reference in its entirety.

### TECHNICAL FIELD

This invention relates to an apparatus and method for remote monitoring of content presentation.

### BACKGROUND

Presently, the monitoring of the showing of a motion picture and the audience in an auditorium is performed by a projectionist in a projection booth observing through a portal. In theaters employing digital cinema projection system, remote monitoring becomes possible. Current digital cinema systems employ remote monitoring techniques to monitor parameters associated with various system elements including projectors, servers, and automation systems. Many exhibitors, however, may not feel comfortable by relying strictly on monitored parameters to gauge whether playout of a feature presentation is occurring satisfactorily in real time, as compared to actual observation by a projectionist or other theater personnel. Thus, it is still desirable to use cameras for remote visual monitoring of the various cinema systems and/or presentation environment.

### SUMMARY OF THE INVENTION

Embodiments of the invention provide a method and a system for remote monitoring of displayed content and its environment.

One embodiment provides a system, which includes a monitoring device for receiving visual information associated with displayed content, and means associated with the monitoring device for generating at least one optical defect within a field of view of the monitoring device for combining with the received visual information.

Another embodiment provides a system, which includes a monitoring device for receiving a visual signal associated with displayed content, and at least one optical component in a field of view of the monitoring device for generating at least one defect for combining with the received visual signal.

Yet another embodiment relates to a method that includes: (a) providing audio-visual information to a monitoring device, in which the audio-visual information contains at least a portion of visual content being displayed, and (b) generating at least one optical defect for combining with the audio-visual information using at least a component in a field of view of the monitoring device.

### BRIEF DESCRIPTION OF THE DRAWINGS

The teachings of the present invention can be readily understood by considering the following detailed description in conjunction with the accompanying drawings, in which:

FIG. 1 depicts a view of an auditorium in accordance with prior art practice;

FIGS. 2a-b depict different views of the auditorium of FIG. 1 as provided in accordance with two embodiments of the present principles;

FIGS. 3a-b illustrate two embodiments of a monitoring system for producing modified views of FIG. 2a-b;

FIG. 4 illustrates another embodiment of a monitoring system for producing the modified view of FIG. 2b;

FIG. 5 depicts a front view of a meter and adjustment about a horizontal axis; and

FIG. 6 depicts another embodiment of a monitoring system for producing a modified view of FIG. 2b.

To facilitate understanding, identical reference numerals have been used, where possible, to designate identical elements that are common to the figures.

### DETAILED DESCRIPTION

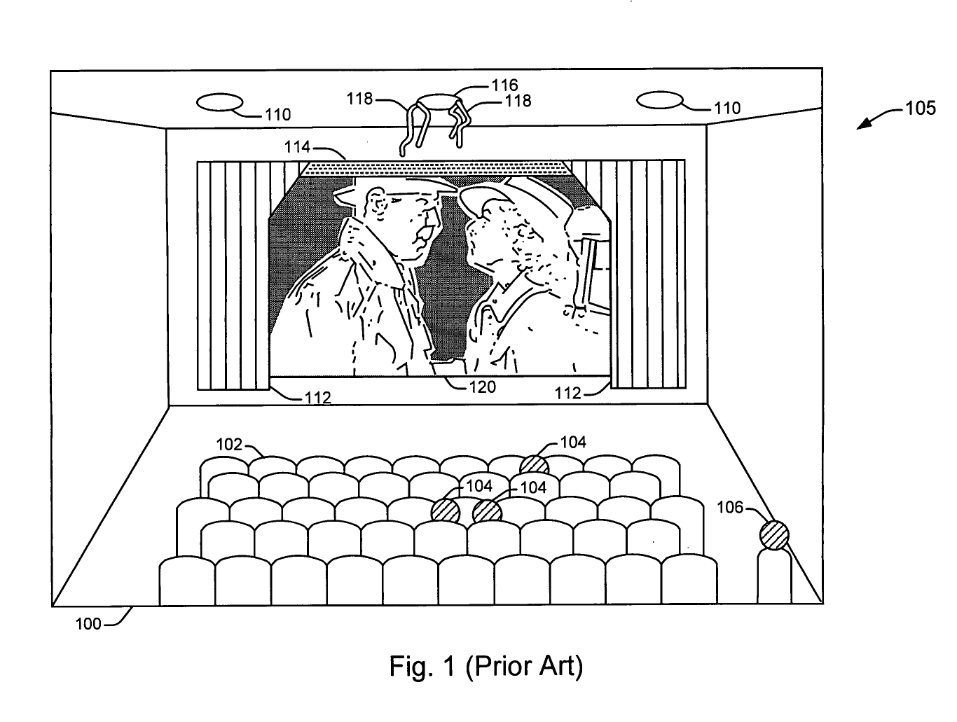

FIG. 1 depicts a view 105 of an auditorium 100, e.g., during the showing of a motion picture or content display, as seen by a monitoring device, e.g., an Axis 223M web camera manufactured by Axis Communications AB of Lund, Sweden, which possesses the ability to provide a high quality, high definition view of an auditorium at a reasonable frame rate. Such a monitoring device may be mounted on or in the ceiling or back wall of the auditorium, or behind a portal in the projection booth. Preferably, such a field of view encompasses the audience seating area 102 so that audience members 104 can be discerned for gauging theater fullness, seating status and audience readiness. Aisles and specific audience member 106 in the theater can also be monitored, for example, in order to assess seating conditions, including whether the audience has finished seating or if there is any difficulty associated with finding a seat.

The view 105 preferably includes a view of at least one auditorium-related equipment such as lights 110, curtains 112, masking 114, fans (not shown) or air conditioning registers 116 whose functional status can be made visible to the remote observer by means of, for example, streamers 118. Also visible in this view is a screen 120 for display of a movie, or more generally, images, videos, or content being presented or displayed. The main speakers are usually absent from the view because they are typically kept behind screen 120. Many theaters also provide surround speakers (not shown), which may be hidden from view within the side and back walls, or may be mounted visibly on wall brackets. In either case, the successful operation of the speakers may not be directly observed with a monitoring camera, unless the camera is provided with or coupled to a microphone, which is transmitting an audio stream along with the captured video of the auditorium.

A high quality image is often necessary to discern audience members or other details of the auditorium status. However, this same high-quality image may pose a concern to content owners (e.g., studios) that someone can easily and undetectably record or stream the camera feed and thereby pirate a movie showing in a theater equipped with such a camera. Thus, the use of a camera for remote monitoring of an auditorium, while useful for automation, may not be favored by studios or content owners.

Embodiments of the present invention provide a method and system of remote monitoring to produce a modified view of the displayed content or presentation and the display environment, while minimizing the risk of unauthorized copying or piracy of the displayed content.

For example, an exhibitor can provide a monitoring device and a component that results in a distorted image of the displayed content (as captured by the monitoring device) so as to render the resulting image substantially unrecoverable or unsuitable for piracy purpose. In another example, a VU (volume unit) meter is also provided in lieu of monitoring the actual audio program, which allows monitoring of the status of the audio play-out, while alleviating any concerns that the soundtrack associated with the displayed content, e.g., a movie, may be remotely pirated.

Different means of generating the distorted image or audio-visual signal input to the monitoring device are illustrated in the following discussions and figures. The term “camera” is also used interchangeably with a monitoring device, and includes different camera types, e.g., video cameras, webcams, whether full color or monochrome. Such cameras may be operating at full-motion frame rates (e.g., 15-30 frames per second, or higher) or may be slower, down to a still image taken every few minutes. Generally, one frame per second or higher is preferred for assessing theater status. The camera can be configured as a stand-alone, local device, or be provided with network capabilities.

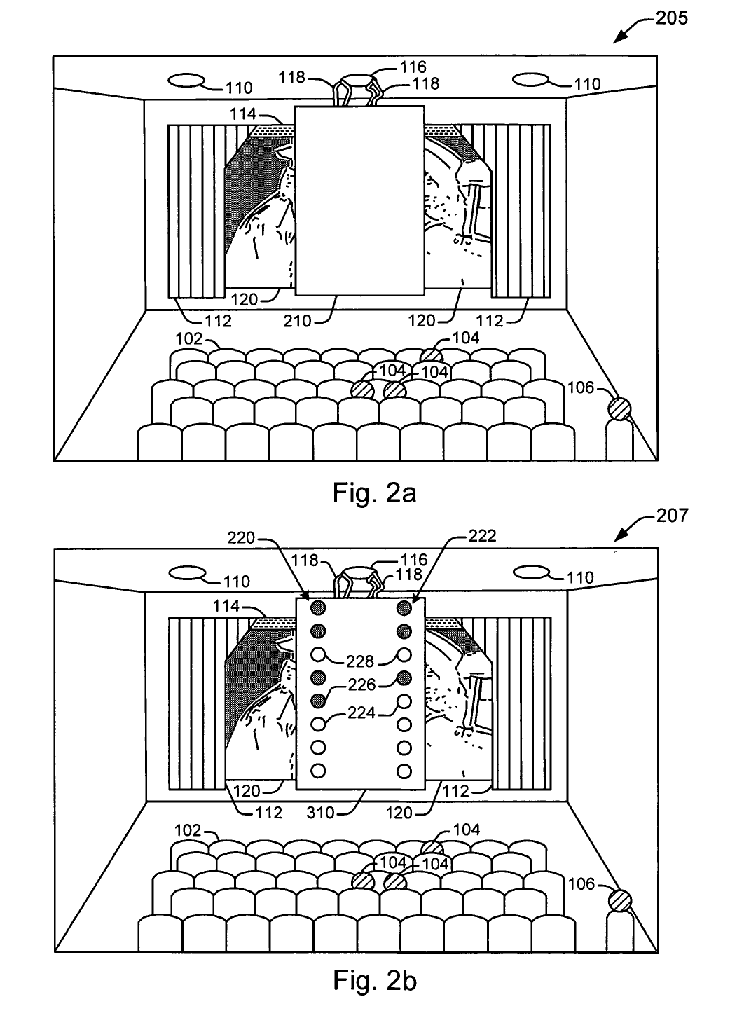

FIG. 2a illustrates a view 205 of the content presentation in the auditorium as seen from the monitoring device in accordance with one embodiment of the present invention. The view 205 is modified compared to that of FIG. 1, and includes a defect or distortion in the image (or visual information) of the displayed content as viewed by the monitoring device. Examples of displayed content include motion pictures, lectures, concerts, live performances or other presentations containing visual content or information. In cases where the presentation includes visual and associated audio content, the content may also be referred to as audio-visual content or information. A component or element 210 is used to generate the optical defect, which is superimposed on or combined with the visual content or signal received by the monitoring device during monitoring of the displayed content. The component 210, which is associated with the monitoring device, may be positioned external to the device. The defect may be an obstruction and/or optical distortion caused by the component 210, which leads to at least an obstructed view or an optically distorted view of the displayed content as viewed by the device. According to embodiments of the invention, the optical defect is generated by a physical means, i.e., an optical effect caused by the use of an actual optical component, and not generated by “virtual” means such as manipulation of electronic signals or by software. In one embodiment, such means is provided within a field of view (either directly in the optical path, or via reflection) of the monitoring device.

Alternatively, the component 210 may also be internal to or be integrated with the device, e.g., as a component of the monitoring device. In this configuration, the defect is generated inside the monitoring device and then combined with the visual signal input to the device. The resulting signal (combined visual signal with the defect) is then detected by one or more sensors of the monitoring device, and any corresponding visual content generated by the device (which may be displayed, recorded, or stored) would also incorporate the defect. That is, any visual content generated by the monitoring device would have an obstructed or distorted view of the originally displayed content, thus providing a deterrent for pirating the recorded content.

It is understood that different positioning and/or sizes of a defect can achieve varying degrees of effectiveness for deterrent purpose. For example, more effective deterrence can be achieved by the defect being positioned near the center of the field of view of the monitoring device, or substantially overlapping a central portion of the screen or image of the displayed content, or having the defect extend across a significant part of the image. A larger size defect may also be less prone to potential attempts at removing the defect.

In one embodiment, component 210 is positioned in a field of view of the monitoring device so that an image of the component 210 is superimposed on the image of the content displayed on screen 120 as viewed by the monitoring device. In one example, the component 210 is an opaque object that obliterates or blocks at least a part of the screen 120 such that a portion of the presentation or displayed content is not visible from the camera's vantage point. This modified view 200 is also referred to as a scarred, defective or distorted view. However, the audience's view of the content displayed on the screen 120 is not affected, i.e., the defect caused by component 210 is not visible to the audience. In alternative embodiments (not shown), component 210 may be at least partially transparent or translucent, and includes a portion that imparts a diffusion, blur, ripple, or other distortions to a part of the image of the displayed content viewed by the monitoring device. This image-distorting portion of component 210 may be made of one or more materials, with different shapes and/or optical properties. Thus, component 210 may include a material having a property that is at least one of: reflective, refractive or diffractive, e.g., one that scatters or re-directs incoming light in directions different from its original path, and may be provided in the form of a lens, prism, diffraction grating, and so on.

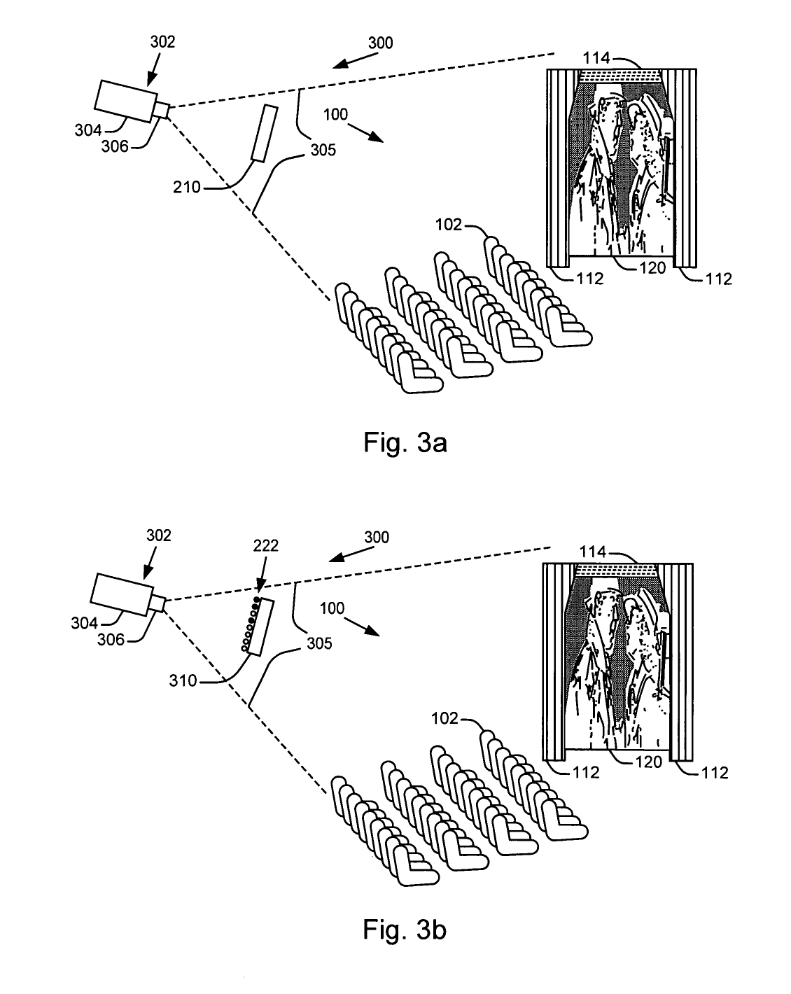

This is further illustrated in FIG. 3a, which shows one embodiment of a system 300 suitable for producing the modified view of FIG. 2a. The system 300 includes a monitoring device 302 and at least one component 210 associated with the monitoring device 302, e.g., both are configured to operate in conjunction with each other, including being aligned with respect to each other according to certain predetermined configuration(s).

As shown in FIG. 3a, component 210 is positioned within a field of view 305 of the monitoring device 302. In one embodiment, component 210 is a physical barrier to light, which is placed such that a significant portion of the screen 120 is obscured in the field of view 305. In one example, the component 210 is positioned such that all light from the screen 120 within the field of view is blocked.

The component 210, which may be positioned at different locations within the field of view of the monitoring device 302, can be provided in different forms or shapes and made of different materials. For example, it may be opaque, or partially transparent or translucent, imparting a diffusion, blur, ripple, or other distortion to the image of the portion of the screen 120 overlaid by component 210 in the field of view of the monitoring device, or a combination thereof; or be provided in the form of a sheet of material, a mirror, diffraction grating, shower glass, lens, prism, including combinations of various surface curvatures, thicknesses and/or optical properties. Component 210 may also comprise a kaleidoscope, such that a portion of the display on screen 120 is replicated (not shown) elsewhere within the portion of field of view 305 subtended by component 210. The component 210 is positioned to produce at least a distortion or defect in the resulting view seen by the monitoring device 302 such that the image of the displayed content is degraded sufficiently to deter piracy of the displayed content.

In one example (not shown), the component 210 is a transparent structure with a pattern of about a dozen colored, translucent dots. In the resulting image of auditorium 100, a central portion of screen 120 (with visual content displayed thereon) appears to have diffuse, colored blotches, rendering the image unsuitable for piracy, but completely adequate for monitoring purposes. Other patterns may also be used in place of dots, which may have a single color (e.g., red, blue, etc.) or different color combinations. In still another embodiment, such dots or patterns may be opaque.

Furthermore, the component 210 does not have to provide a contiguous region (or a single continuous region) for blocking or distorting the image of the displayed content for the monitoring device 302. Instead, the component 210 may include a number of discrete or non-contiguous portions. For example, a checkerboard pattern, in which half of the screen is visible and half of the screen is obscured, may be used so long as the scarring or distortion is sufficient to guard against piracy, or be acceptable to the content providers, e.g., studios.

In still other embodiments (not shown), component 210 may be non-stationary. For example, component 210 may comprise a blade that rotates or oscillates within or through field of view 305. Over time, this would allow the entire auditorium 100 to be inspected, including for instance, the center of screen 120. This is useful to ensure that screen 120 does not have a stain or damage that would otherwise be obscured by a static component 210. Preferably, such a rotation or oscillation has a frequency that is different from a multiple of the camera's frame rate, which can avoid a scenario in which the component 210 appears to be substantially stationary (due to “synchronization” with the camera's frame rate).

In addition to video signals, many monitoring devices are capable of receiving audio signal inputs, e.g., via a built-in or external microphone. If the monitoring device 302 has such an audio input/recording capability (not shown, but present in the exemplary product Axis Communication product previously mentioned), it may also be configured to suppress the audio input, so that the audio component of the audio-visual information (corresponding to the displayed content) will not be provided to or recorded by the monitoring device. Alternatively, a distortion or defect (e.g. a continuous noise source or a frequently gated mute or noise source) may also be introduced to at least a portion of the audio signal input such that the resulting audio information is degraded sufficiently to render it undesirable or non-usable for pirating purpose. With no usable audio signal available, hackers cannot gain access to the movie sound track from the camera.

Even without an audio input to the monitoring device 302, the status of the audio component can nonetheless be monitored by visual indicators. In one embodiment, at least one gauge or meter is provided in the field of view 305. For example, a stereo VU (volume unit) meter or indicator may be used to provide visual monitoring of the status of the audio portion of the performance. As shown in FIG. 2b, in addition to the obstructed image provided by component 310, a separate left-channel gauge 220 and right channel gauge 222 are provided in another modified view 207.

While classical analog meters can be used, a common solid state implementation suitable for gauges 220 and 222 is a light emitting diode (LED) bar graph. In such an implementation, a fast-acting lower portion of the bar graph would be represented by contiguous lit LEDs topped by LEDs 224 in their respective left and right channel gauges. Often, un-lit LEDs 226 may be found above the contiguous portion. Preferably, a single LED 228 on each of the channels denotes the recent peak audio level, and may best represent the audio level as recently experienced by the audience.

By watching VU meters 220 and 222 through the scarred view 207 provided by a monitoring system of the present invention, an operator can discern whether or not the audio is playing. In one embodiment, the operator can introduce a test signal into the speakers of an auditorium, e.g., when no audience or exhibitor staff is present in the auditorium, and assuming that the display of gauges 220 and 222 are calibrated, an actual measurement of the auditorium audio settings can be performed.

Such a modified view can be achieved by a system configuration such as that shown in FIG. 3b, in which component 310, in addition to providing a defect or distortion to the displayed content image (as with component 210 above), may also include the VU meter of FIG. 2b. In FIG. 3b, the LEDs for the right channel gauge 222 of the VU meter are shown in the side view of component 310. Component 310 may further include directional microphones (not shown) with sufficient amplification to drive gauges 220 and 222. Alternatively, the VU meter gauges may also be provided separately from component 310, but still within the field of view 305 of the monitoring device 302.

In yet another embodiment (not shown), component 210 or component 310 and gauges 220 and 222 can be incorporated within the housing 304 or lens 306 of camera 302. While such integration may make the system 300 more tamper-resistant, it may also make a visual inspection of the camera (e.g., to detect possible tampering) more difficult. If gauges 220 and 222 are implemented as a transmissive LCD display, then light from screen 120, appropriately distorted by component 310 to provide desired content protection, may serve as the backlight to the LCD.

Other gauges can also be made available within the region subtended by component 310, or elsewhere within the field of view 305. For example, another suitable location for these gauges would be the upper half of the left and right extremes of the scarred view 205, which, for most auditoriums, will be empty wall space. Another example of gauges that can be used in conjunction with the scarred view would be a thermometer for monitoring air temperature. It is understood that other features of interest to digital cinema automation may also be used in conjunction with one or more embodiments of the invention.

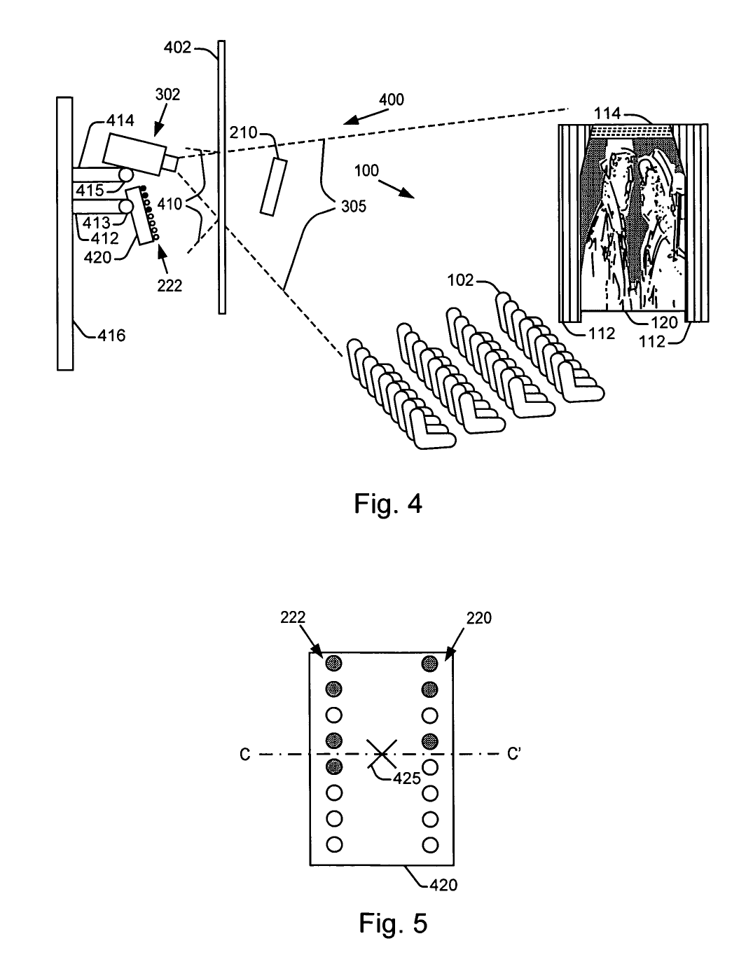

FIG. 4 shows another embodiment of a monitoring system 400 that includes camera 302 and VU meter 420. In this embodiment, camera 302 still provides a view similar to the scarred view 207 shown in FIG. 2b. However, in this configuration, the VU meter 420 is mounted inside the projection booth and viewed by camera 302 in a reflected field of view 410 provided by a beam splitter 402, e.g., a portal glass. To facilitate alignment of camera 302 so that field of view 305 produces the desired scarred image, e.g., image 207 of FIG. 2b, camera 302 is mounted on bracket 416 on a first or upper arm 414. Camera 302, which is pivotably connected to upper arm 414, can be adjusted about a pivot 415 in various directions, e.g., in vertical and horizontal planes, and combination thereof, for alignment purpose. After the camera 302 has been aligned to produce a desired view or image, it can be fixed in position using one or more fasteners (not shown). In another embodiment, the camera may also be provided with a scanning capability, e.g., an adjustable field of view, and the scarring component may be adapted accordingly so that it remains aligned with respect to the image (e.g., near a central portion) of the displayed content for producing a defect in the resulting monitored view.

To facilitate alignment of VU meter 420 in the reflected field of view 410, meter 420 is attached at a pivot 413 to a second movable arm 412, which, in this example, is positioned below the first arm 414. By adjusting lower arm 412 up and down along the bracket 416 and meter 420 about the pivot 413, an image of the meter 420 can be superimposed with element 210, resulting in a scarred view similar to that of view 207 of FIG. 2b. The pivotable connection between lower arm 412 and meter 420 can be adjusted to minimize foreshortening of meter 420 caused by a perspective view. In one embodiment, pivot 413 comprises a pivoting pin substantially at the center 425 of the meter 420 such that the meter 420 can be rotated about a horizontal axis C-C through the plane of the meter 420. This is illustrated in FIG. 5. Such a configuration allows the horizontal axis of meter 420 to be substantially parallel to the reflective surface or the portal glass, which results in the upper and lower LEDs (in either the left or right meter) having the same size in the resulting view as seen by the monitoring device, as well as maintaining an appearance of the two meters 220 and 222 being parallel to each other. In cases where the vertical centerline of field of view 305 is not coplanar with the vertical centerline of reflected field of view 410, a lateral adjustment of meter 420 with respect to camera 302 may be required to keep the image of meters 220 and 222 centered within the image of component 210; and further, rotation of meter 420 about its vertical axis may be required to minimize foreshortening caused by the horizontal displacement.

If VU meter 420 is located in the projection booth, electrical audio signals generated by the projection system (not shown) can be used as inputs to the meter 420. Alternatively, amplified signals from microphones (not shown) in the auditorium 100 may also be used as inputs to the meter in the booth.

In general, for use with VU meter 420, component 210 may be placed at any locations on the same side of beam splitter 402 as screen 120, so long as it subtends a region of the screen sufficient to render the resulting view of the displayed content unsuitable for pirating purpose, e.g., similar to that shown in FIG. 2a. If VU meter 420 is not being used (as in FIG. 2a), it does not matter on which side of the port glass (i.e., beamsplitter 402) component 210 is placed, so long as it subtends a similarly sufficient region, as above.

It is preferable that camera systems 300 or 400 providing scarred views 205 or 207 of the same content presentation be configured to provide a certain level of “uniformity” of scars or distortions, e.g., at least one defect produced by different cameras 302 in different auditoriums 100 appears at substantially the same location in the resulting images 205 and/or 207. Such an arrangement can prevent the audio-visual information from multiple cameras 302 from being synchronized and superimposed (or combined), e.g., by using an undistorted portion of a movie from one camera in a first auditorium to replace a distorted portion of the movie from another camera in a second auditorium, for producing a composite copy that is adequate for piracy purpose. The same restriction applies to different monitoring cameras used in a single auditorium (more than one monitoring camera might be needed to adequately survey an audience in very wide theaters or theaters having balconies).

In the embodiment of FIG. 4, the production of the distorted image is facilitated by the beam splitter 402, which allows the images of the VU meter 420 and component 210 to be combined in the modified view.

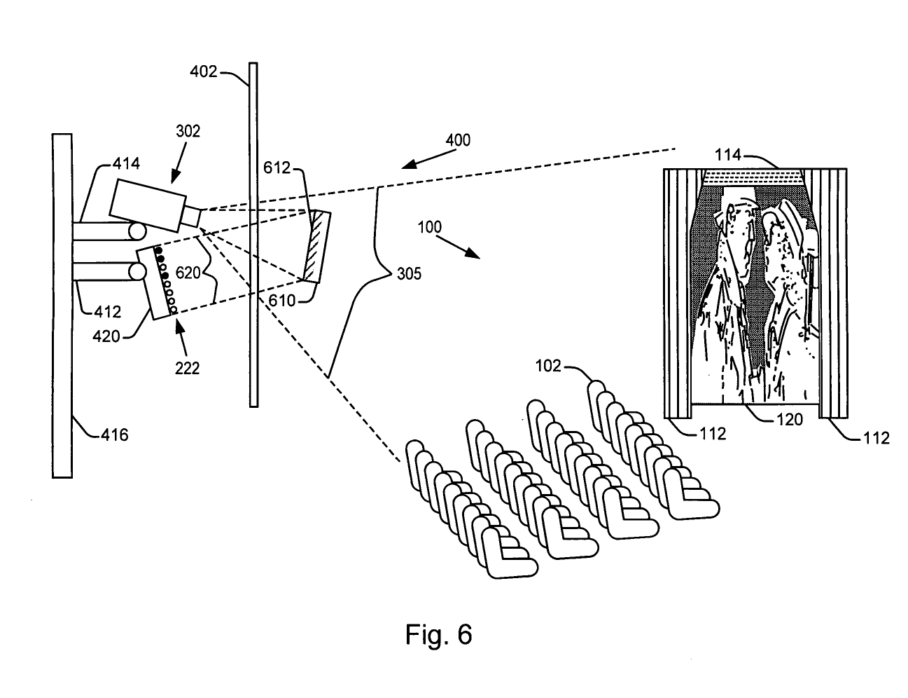

Another optical element, e.g., a mirror, may also be used as a defect-inducing component 610 having a reflective surface 612, which, when properly aligned such that a reflected field of view 620 lies within field of view 305 as seen by camera 302, also provides a reflected image of the meter 420 in the modified view seen by the camera 302. This is illustrated in FIG. 6.

In another configuration (not shown), a portion of the portal glass 402 in the field of view 305 may also be replaced by a mirror, which serves to obstruct a portion of the displayed content image, as well as to provide an image of the VU meter 420 to the camera 302.

In the above examples, an actual VU meter is used to produce the image of VU meter for superimposing on the image of component 210. In other embodiments, instead of using a physical VU meter, an electronically generated signal (corresponding to an image of a VU meter), or a computationally generated image of a VU meter, can be superimposed on the image of component 210. Furthermore, a second camera can also be used to view a physical VU meter and the image streams from the two cameras can be superimposed or keyed to generate a view such as that shown in FIG. 2b.

Although embodiments of the invention are particularly valuable in digital cinema venues, they are also applicable to other display environments including live venues (e.g., concerts or lectures), theaters, film presentations, and so on.

While the forgoing is directed to various embodiments of the present invention, other and further embodiments of the invention may be devised without departing from the basic scope thereof. As such, the appropriate scope of the invention is to be determined according to the claims, which follow.

1. A system, comprising:
a monitoring device for receiving visual information associated with displayed content; and
means associated with the monitoring device for generating at least one optical defect within a field of view of the monitoring device for combining with the received visual information.

2. The system of claim 1, wherein the at least one optical defect includes one of an obstruction and a distortion.

3. The system of claim 2, further comprising a means for generating one of an omission and distortion of at least a portion of an audio signal associated with the displayed content.

4. The system of claim 2, wherein the means includes a component positioned in a field of view of the monitoring device.

5. The system of claim 4, wherein at least a portion of the component has a property that is at least one of opaque, translucent, reflective, refractive and diffractive.

6. The system of claim 1, further comprising means for providing a visual indication of at least one parameter associated with one of a display environment and the displayed content.

7. The system of claim 4, wherein the at least one parameter is one of a temperature of the display environment and a volume of an audio component.

8. The system of claim 7, wherein the display environment is one of a digital cinema, a theater and a live performance venue.

9. The system of claim 1, wherein said means is internal to the monitoring device.

10. The system of claim 1, wherein said means is external to the monitoring device.

11. A system, comprising:
a monitoring device for receiving a visual signal associated with displayed content; and
at least one component in a field of view of the monitoring device for generating at least one optical defect for combining with the received visual signal.

12. The system of claim 11, wherein the at least one optical defect includes one of an obstruction and an optical distortion.

13. The system of claim 12, wherein the at least one component is configured for one of rotation and oscillation in a field of view of the monitoring device.

14. The system of claim 11, further comprising a means for generating a visual indicator of at least one parameter associated with one of a display environment and the displayed content.

15. A method, comprising:
(a) providing audio-visual information to a monitoring device, wherein the audio-visual information contains visual content being displayed; and
(b) generating at least one optical defect for combining with the audio-visual information using at least a component in a field of view of the monitoring device.

16. The method of claim 15, further comprising:
providing at least one of an obstructed view and a distorted view of the displayed content.

17. The method of claim 15, wherein the audio-visual information includes an image from a presentation of visual content, and wherein the at least one optical defect is positioned in a central region of the image.

18. The method of claim 15, wherein step (a) further comprises:
one of omitting and distorting at least a portion of an audio signal from the audio-visual information, the audio signal being associated with the displayed content.

19. The method of claim 15, further comprising:
including in the audio-visual information a visual indication of at least one parameter associated with one of a display environment and the displayed content.

20. The method of claim 19, wherein the at least one parameter is one of a volume of an audio signal and a temperature of the display environment.
